(19) United States
(12) Patent Application Publication
(10) Pub. No.: US 2025/0335738 A1
(43) Pub. Date: Oct. 30, 2025

(54) DISTRIBUTED INFERENCE METHOD FOR LARGE MODEL AND ELECTRONIC DEVICE

(71) Applicant: ELECTRONICS AND TELECOMMUNICATIONS RESEARCH INSTITUTE, Daejeon (KR)

(72) Inventors: Munyoung LEE, Daejeon (KR); Min Ho BAE, Daejeon (KR); Dohun KIM, Daejeon (KR); Hyunwoo KIM, Daejeon (KR); Sung Jae YOON, Daejeon (KR)

(73) Assignee: ELECTRONICS AND TELECOMMUNICATIONS RESEARCH INSTITUTE, Daejeon (KR)

(21) Appl. No.: 19/187,748

(22) Filed: Apr. 23, 2025

(30) Foreign Application Priority Data
Apr. 24, 2024 (KR) 10-2024-0054868
Mar. 6, 2025 (KR) 10-2025-0028866

(51) Int. Cl. G06N 3/04

(52) U.S. Cl. CPC G06N 3/04

(57) ABSTRACT

An electronic device performs operations for distributed inference of a large model. The electronic device includes one or more memories and one or more processors. The one or more processors partition a deep learning model stored in the one or more memories into a plurality of sub-models based on the deep learning model and input data associated with the deep learning model, distribute and schedule the plurality of sub-models to an internal resource device and an external resource device based on the input data of each of the plurality of sub-models, receive inference results of each sub-model from the internal resource device and the external resource device, and calculate results of the deep learning model through the received inference results.

### CROSS-REFERENCE TO RELATED APPLICATION

This application claims priority to and the benefit of Korean Patent Application No. 10-2024-0054868, filed on Apr. 24, 2024, and Korean Patent Application No. 10-2025-0028866, filed on Mar. 6, 2025, the disclosure of which is incorporated herein by reference in its entirety.

### BACKGROUND

### 1. Field of the Invention

The present invention relates to a distributed inference method for a large model and an electronic device, and more particularly, to a distributed inference method for a large model that is capable of distributed inference processing of a large model, and an electronic device.

### 2. Discussion of Related Art

Artificial intelligence (AI) large models refer to deep learning models with large scale parameters. These AI large models have more than several billion weight parameters and are trained with a large number of datasets to be used for various tasks such as natural language understanding, image classification, and speech recognition. Examples of representative AI large models include the Generative Pre-trained Transformer (GPT) developed by OpenAI and Gemini developed by Google in the United States.

Since large computing resources are required to perform the AI large models, the AI large models may not be performed in an environment where there is an insufficiency related to their own internal infrastructure resources. As an alternative to solving the resource shortage problem, there is a method of performing AI large models using external infrastructure resources (cloud services and the like). However, in the case of performing the AI large models using the external infrastructure resources, there is a problem in that sensitive data of companies may be exposed in the process of transmitting data required for inference to external infrastructure resources through a network.

### SUMMARY OF THE INVENTION

The present invention is directed to providing a distributed inference method for a large model that is capable of distributed inference processing of the large model by lightening (model lightweighting) and partitioning the large model, linking the lightened and partitioned large model to internal infrastructure resources and external infrastructure resources, and then adaptively scheduling the large model in consideration of contents of input data and specifications of available internal/external resources.

According to an aspect of the present invention, there is provided an electronic device, including: one or more memories; and one or more processors, in which the one or more processors may partition a deep learning model stored in the one or more memories into a plurality of sub-models based on the deep learning model and input data associated with the deep learning model, distribute and schedule the plurality of sub-models to an internal resource device and an external resource device based on the input data of each of the plurality of sub-models, receive inference results of each sub-model from the internal resource device and the external resource device, and calculate results of the deep learning model through the received inference results.

The input data associated with the deep learning model may be partitioned into data allowed (permitted) to be transmitted only to the internal resource device and data allowed to be also transmitted to the external resource device.

The one or more processors may allocate a sub-model to which the data allowed to be transmitted only to the internal resource device is input to the internal resource device.

The one or more processors may perform the distributed scheduling by further considering specifications of the internal resource device and the external resource device.

When the internal resource device does not process all of the sub-models to which the data allowed to be transmitted only to the internal resource device is input, the one or more processors may partition a layer of a neural network of the sub-model to which the data allowed to be transmitted only to the internal resource device is input and allocate a layer closer to an input side among the partitioned layers to the internal resource device.

When the internal resource device does not process all of the sub-models to which the data allowed to be transmitted only to the internal resource device is input, the one or more processors may allocate an input tensor of the sub-model to which the data allowed to be transmitted only to the internal resource device is input to the internal resource device.

The internal resource device and/or the external resource device may include a plurality of devices having different data throughput, and the one or more processors may partition the plurality of sub-models into at least some of the plurality of sub-models having different sizes in consideration of the data throughput of the internal resource device and the external resource device.

The deep learning model may be a large model.

According to another aspect of the present invention, there is provided a distributed inference method for a large model, including: partitioning a deep learning model into a plurality of sub-models based on the deep learning model and input data associated with the deep learning model; distributing and scheduling the plurality of sub-models to an internal resource device and an external resource device based on the input data of each of the plurality of sub-models; transmitting each sub-model and input data to the internal resource device and the external resource device; receiving inference results of each sub-model from the internal resource device and the external resource device, and calculating results of the deep learning model through the received inference results.

According to still another aspect of the present invention, there is provided a distributed inference method for a large model, including: partitioning a deep learning model into a plurality of sub-models based on the deep learning model and input data associated with the deep learning model; distributing and scheduling the plurality of sub-models to an internal resource device and an external resource device based on input data of each of the plurality of sub-models, the input data associated with the deep learning model being partitioned into data allowed to be transmitted only to the internal resource device and data allowed to be also transmitted to the external resource device; and transmitting each sub-model and input data to the internal resource device and the external resource device.

### BRIEF DESCRIPTION OF DRAWINGS

The above and other objects, features, and advantages of the present invention will become more apparent to those of ordinary skill in the art by describing exemplary embodiments thereof in detail with reference to the accompanying drawings, in which:

FIG. 1 is a block diagram illustrating a distributed inference system for a large model according to an embodiment of the present invention;

FIG. 2 is an exemplary diagram describing an operation of partitioning neural network of a sub-model and allocating the partitioned neural network to internal and external infrastructure resources;

FIG. 3 is an exemplary diagram describing a scheduling module;

FIG. 4 is a flowchart for describing a distributed inference method for a large model according to an embodiment of the present invention; and

FIG. 5 is a block diagram illustrating an electronic device according to an embodiment of the present invention.

### DETAILED DESCRIPTION OF EXEMPLARY EMBODIMENTS

Hereinafter, embodiments of a distributed inference method for a large model and an electronic device according to the present invention will be described with reference to the attached drawings. In this process, thicknesses of lines, sizes of components, and the like illustrated in the accompanying drawings may be exaggerated for clarity of explanation and convenience. In addition, terms to be described below are defined in consideration of functions in the present disclosure and may be construed in different ways by the intention of users or practice. Therefore, these terms should be defined on the basis of the contents throughout the present specification.

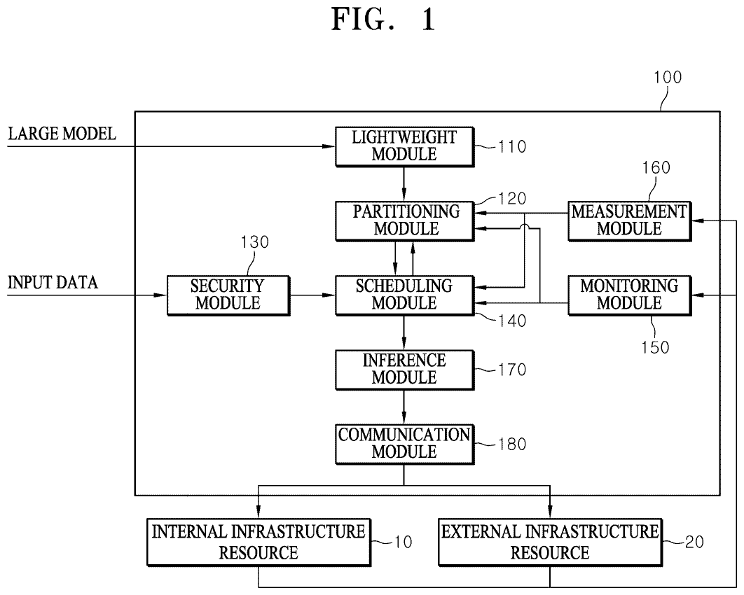

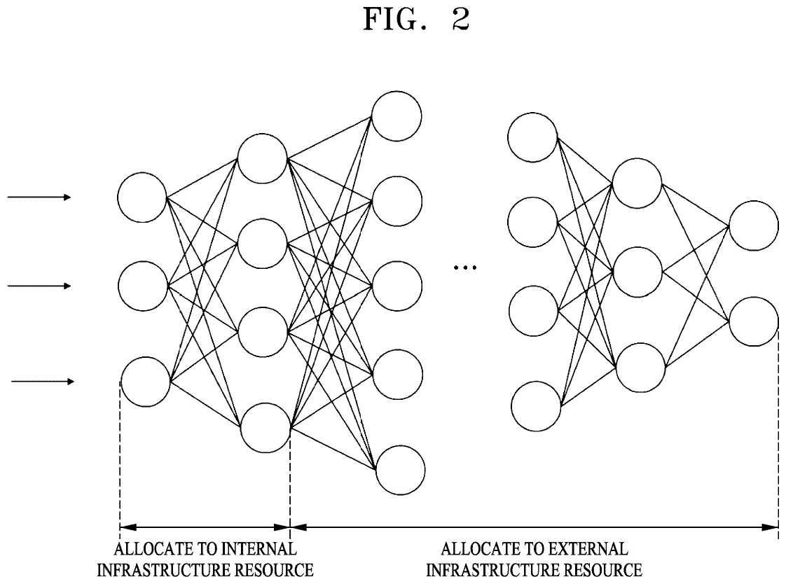

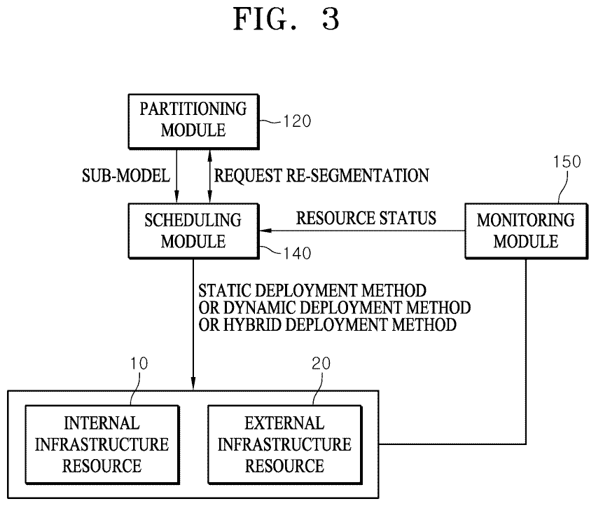

FIG. 1 is a block diagram illustrating a distributed inference system for a large model according to an embodiment of the present invention, FIG. 2 is an exemplary diagram describing an operation of partitioning neural network of a sub-model and allocating the partitioned neural network to internal and external infrastructure resources, and FIG. 3 is an exemplary diagram describing a scheduling module.

Referring to FIG. 1, a distributed inference system 100 according to the embodiment of the present invention may include a lightweight module 110, a partitioning module 120, a security module 130, a scheduling module 140, a monitoring module 150, a measurement module 160, an inference module 170, and a communication module 180.

The lightweight module 110 may compress and/or lighten (model lightweighting) a deep learning model. The deep learning model may be a large model. The large model may mean a deep learning model that requires a lot of computing resources for computation and cannot be executed on a single device. The lightweight module 110 may convert a size of the deep learning model into a smaller and more efficient form by using technologies such as quantization, pruning, knowledge distillation, model compression, neural architecture search (NAS), singular vector decomposition (SVD), and sparsity. In various embodiments, the lightweight module 110 may be omitted from the distributed inference system 100. When the deep learning model is compressed and/or lightened, accuracy of the deep learning model may be reduced, and therefore, when it is important to provide the accuracy of the deep learning model, the lightweight module 110 may be omitted from the distributed inference system 100.

The partitioning module 120 may partition the deep learning model into a plurality of sub-models. The partitioning module 120 may partition the deep learning model into a plurality of sub-models based on the deep learning model and input data associated with the deep learning model. The partitioning module 120 may partition the deep learning model in consideration of a layer of a neural network, a weight, contents of the input data, specifications of the internal infrastructure resource 10 and the external infrastructure resource 20, etc.

In the present embodiment, the internal infrastructure resource 10 may refer to computing resources (edge server, hardware accelerator-equipped server, edge terminal, etc.) that are owned by an enterprise environment such as a company, a public institution, or a factory and may also be referred to as an internal resource device. In the present embodiment, the external infrastructure resource 20 may refer to computing resources (cloud server and the like) provided from the outside and may also be referred to as an external resource device. Each of the internal and external infrastructure resources 10 and 20 may include devices, such as a server, an AI accelerator, a PC, and a small-scale computing device (user terminal, IoT device, etc.).

An accelerator, which is a hardware device for accelerating the inference of the deep learning model, may be installed in each device within the internal and external infrastructure resources 10 and 20. The accelerator may serve to improve the power usage efficiency of each device within the internal and external infrastructure resources 10 and 20 and improve the inference speed. In various embodiments, the accelerator may be installed only in each device within the internal infrastructure resources 10 or only in each device within the external infrastructure resources 20. In various embodiments, the accelerator may not be installed in each device within the internal and external infrastructure resources 10 and 20. The accelerator may include computational devices, such as a graphics processing unit (GPU), a field-programmable gate array (FPGA), and an application-specific integrated circuit (ASIC), and communication interfaces, such as a peripheral component interconnect express (PCIe) and a universal serial bus (USB). A plurality of sub-models may be executed in parallel by the internal and external infrastructure resources 10 and 20. The present embodiment may execute the deep learning model by using the internal and external infrastructure resources 10 and 20 together, thereby overcoming the limitations of a single infrastructure resource and improving the inference speed.

In various embodiments, the partitioning module 120 may partition the deep learning model so that at least some of the plurality of sub-models have different sizes in consideration of the specifications of the internal infrastructure resource 10 and the external infrastructure resource 20. Data throughput of each device in the internal and external infrastructure resources 10 and 20 may be different, and the partitioning module 120 may determine the sizes of each sub-model in consideration of the data throughput of each device in the internal and external infrastructure resources 10 and 20. The partitioning module 120 may partition the deep learning model so that available resources are utilized to the maximum extent.

The partitioning module 120 may receive information on the status of the internal and external infrastructure resources 10 and 20 from the monitoring module 150 and the scheduling module 140 and may partition the deep learning model based on the received information. In this case, the partitioning module 120 may calculate an objective function for energy saving, cost saving, or performance optimization and partition the deep learning model according to the calculated results. In this case, at least some of the plurality of sub-models may have a different size. The partitioning module 120 may optimize the objective function through a rule-based algorithm, reinforcement learning, etc. The objective function used in the process of partitioning the deep learning model may be a single objective function (e.g., an objective function for energy saving) or a multi-objective objective function (e.g., an objective function for energy saving and performance optimization). For example, when using the objective function for energy saving, the objective function may be calculated using the throughput compared to the energy usage of each device in the internal and external infrastructure resources 10 and 20 as an indicator.

The security module 130 may determine whether the input data associated with the deep learning model includes sensitive information. In the present embodiment, the sensitive information is information that should be prevented from being exposed externally and may include, for example, personal information of a user or a company, confidential information, restricted information, etc. The security module 130 may confirm whether the input data associated with the deep learning model includes the sensitive information through a predefined rule filtering or analysis algorithm. The input data associated with the deep learning model may be partitioned into data including the sensitive information and data not including the sensitive information.

In the present embodiment, the data including the sensitive information is transmitted only to the internal infrastructure resource 10 by the scheduling module 140, so the data including the sensitive information may be referred to as data that may be transmitted only to the internal resource device. In the present embodiment, the data not including the sensitive information is transmitted to the internal and/or external infrastructure resource 10 and/or 20 by the scheduling module 140, so the data not including the sensitive information may be referred to as the data that may also be transmitted to the internal resource device. In various embodiments, when data without security issues is used as the input data of the deep learning model, the security module 130 may be omitted from the distributed inference system 100.

The scheduling module 140 may allocate the plurality of sub-models to the internal and external infrastructure resources 10 and 20 so that the plurality of sub-models may be processed in parallel (executed in parallel) by the internal and external infrastructure resources 10 and 20. The scheduling module 140 may allocate the plurality of sub-models to the internal and external infrastructure resources 10 and 20 based on the input data of each of the plurality of sub-models.

The scheduling module 140 may allocate the sub-model to which the data including the sensitive information is input to the internal infrastructure resource 10. In the present embodiment, by allocating the sub-model using the data including the sensitive information as the input data to the internal infrastructure resource 10, it is possible to prevent the sensitive information from being exposed to the outside during the inference process. The scheduling module 140 may receive information on whether the input data of any sub-model includes the sensitive information from the security module 130.

The scheduling module 140 may allocate the plurality of sub-models by additionally considering the specifications of the internal and external infrastructure resources 10 and 20. When the internal infrastructure resource 10 may not process all of the sub-models to which the data including the sensitive information is input, as illustrated in FIG. 3, the scheduling module 140 may partition layers of a neural network of the corresponding sub-model and allocate layers (e.g., layers from an input layer to an n-th layer) close to the input side among the partitioned layers to the internal infrastructure resource 10. In the present embodiment, by allocating only a portion of the front of the layers constituting the neural network of the sub-model that uses the data including the sensitive information as the input data to the internal infrastructure resource 10 and allocating the remaining layers of the corresponding neural network to the external infrastructure resource 20, it is possible to prevent the sensitive information from being exposed to the outside during the inference process even when all of the sub-models to which the sensitive information is input may not be processed through the internal infrastructure resource 10. In various embodiments, the scheduling module 140 may also de-identify or encrypt the data including the sensitive information.

The scheduling module 140 may allocate an input tensor of the corresponding sub-model, which inputs data including sensitive information, to the internal infrastructure resource 10 when the internal infrastructure resource 10 may not process all of the sub-models. In the present embodiment, by allocating the input tensor of the sub-model that uses the data including the sensitive information as the input data to the internal infrastructure resource 10 and allocating the remaining portion of the corresponding sub-model to the external infrastructure resource 20, the input processing for the sensitive information may be performed by the internal infrastructure resource even when all of the sub-models to which the sensitive information is input may not be processed through the internal infrastructure resource 10, thereby preventing the sensitive information from being exposed to the outside during the inference process.

The scheduling module 140 may set priorities for available resources according to a predefined resource usage policy and may also allocate the plurality of sub-models according to the set priorities. The resource usage policy may include information on resources (devices) that should be used by being prioritized, total usage budget (cloud usage budget and the like), task completion time, maximizing total throughput, etc. The scheduling module 140 may also allocate the sub-models by considering the operations supported by the accelerators installed in each device within the internal and external infrastructure resources 10 and 20. When a specific operation is required during the inference process, the scheduling module 140 may allocate the sub-models related to the specific operation to a resource (device) in which the accelerator supporting the specific operation is installed.

The scheduling module 140 may deploy the plurality of sub-models to the internal and external infrastructure resources 10 and 20 using any one of a static deployment method, a dynamic deployment method, and a hybrid deployment method.

The static deployment method may be a method of pre-deploying the plurality of sub-models generated by the partitioning module 120 to each device within the internal and external infrastructure resources 10 and 20 so that each device within the internal and external infrastructure resources 10 and 20 may load the sub-models into memory in advance. The static deployment method has the advantage of being able to perform inference quickly. For example, when deploying sub-models A1, A2, A3, and A4 of deep learning model A to infrastructure resources a, b, c, and d using the static deployment method, the scheduling module 140 may pre-deploy the sub-models A1, A2, A3, and A4 of model A to the infrastructure resources a, b, c, and d.

The dynamic deployment method may be a method of deploying the plurality of sub-models generated by the partitioning module 120 to each device within the internal and external infrastructure resources 10 and 20 in real time. The dynamic deployment method incurs overhead equal to the time required to the sub-model to be loaded into the memory of each device, but has the advantage of providing a more elastic and flexible inference service. When deploying the sub-model using the dynamic deployment method, the scheduling module 140 may determine a sub-model to be deployed and a device (a device for performing the corresponding sub-model) to receive the corresponding sub-model by considering the status of the internal and external infrastructure resources 10 and 20 in real time. For example, when deploying the sub-models A1, A2, A3, and A4 of the deep learning model A to the infrastructure resources a, b, c, and d using the dynamic deployment method, the scheduling module 140 may determine in real-time the sub-model to be deployed among the sub-models of the model A and the infrastructure resources to receive the corresponding sub-model according to the predefined priority (performance, power consumption, etc.) and may perform the process of deploying the corresponding sub-models to the determined infrastructure resources until the deployment of the sub-models A1, A2, A3, and A4 is completed. The hybrid deployment method may be a method in which the static deployment method and the dynamic deployment method are combined. In the case of the hybrid deployment method, the sub-models may be pre-deployed to some of the plurality of devices included in the internal and external infrastructure resources 10 and 20, and the sub-models may be deployed to the remaining devices in real time by considering the status of the internal and external infrastructure resources 10 and 20. The hybrid deployment method may maximize the use of the advantages of both the static and dynamic deployment methods. For example, when deploying the sub-models A1, A2, A3, and A4 of the deep learning model A to the infrastructure resources a, b, c, and d using the hybrid deployment method, the scheduling module 140 may pre-deploy the sub-models A1 and A2 to the predetermined infrastructure resources a and b and deploy the sub-models A3 and A4 to the available infrastructure resources c and d in real time. The scheduling module 140 may also reallocate the plurality of sub-models by considering the information on the status of the internal and external infrastructure resources 10 and 20 collected through the monitoring module 150. The scheduling module 140 may also reallocate the plurality of sub-models by considering the power consumption of each device in the external and internal infrastructure resources 10 collected through the measurement module 160. The scheduling module 140 may determine whether the inference performance deteriorates from the information on the status of the internal and external infrastructure resources 10 and 20 collected through the monitoring module 150, and when it is determined that the inference performance deteriorates, the scheduling module 140 may request the partitioning module 120 to re-partition the deep learning model. The operation of the scheduling module 140 may be constituted as illustrated in FIG. 3.

The monitoring module 150 may collect and manage the information on the status of the internal and external infrastructure resources 10 and 20. The information on the status of the internal and external infrastructure resources 10 and 20 may include various information related to the internal and external infrastructure resources 10 and 20, such as information (information indicating how much data (sub-model) has been allocated to each device of the internal and external infrastructure resources 10 and 20) on the usage status of the internal and external infrastructure resources 10 and 20 and information on the progress of the inference task.

The measurement module 160 may collect and manage the information on the power consumption of each device within the internal and external infrastructure resources 10 and 20. In some cases, the measurement module 160 may be omitted from the distributed inference system 100.

The inference module 170 may perform the distributed inference using the internal and external infrastructure resources 10 and 20. The inference module 170 may acquire inference results by executing the plurality of sub-models allocated to the internal and external infrastructure resources 10 and 20 to perform the distributed processing of the inference of the deep learning model. The plurality of sub-models may be processed in parallel by the internal and external infrastructure resources 10 and 20, so the time required for inference may be shortened. In various embodiments, the inference module 170 may be omitted from the distributed inference system 100. In this case, the process of acquiring the inference results may be performed by another device.

The communication module 180 may perform communication with each device within the internal and external infrastructure resources 10 and 20. The communication module 180 may serve to connect the distributed inference system 100 and the internal and external infrastructure resources 10 and 20. The communication module 180 may perform communication with each device within the internal and external infrastructure resources 10 and 20 using a communication protocol such as transmission control protocol/Internet protocol (TCP/IP) or user datagram protocol (UDP), but is not limited thereto. For example, the communication module 180 may perform communication using a separate communication protocol aimed at minimizing communication delay time or may perform communication using a communication protocol that takes into account the time when an edge device using a battery enters a sleep mode for power saving.

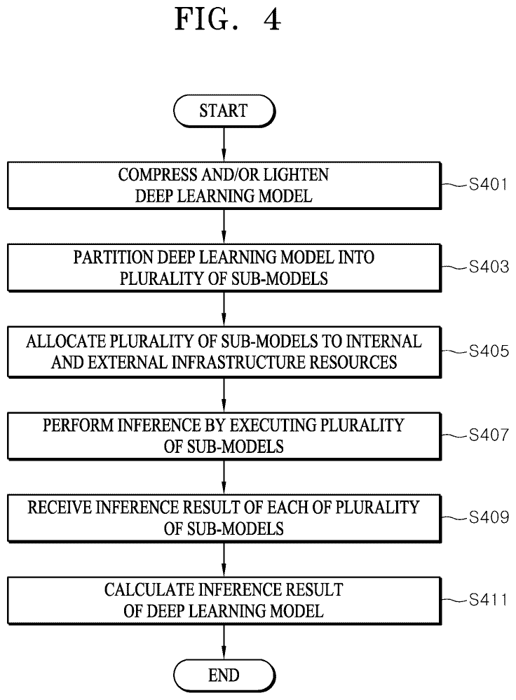

FIG. 4 is a flowchart of a distributed inference method for a large model according to an embodiment of the present invention.

Hereinafter, a distributed inference method for a large model according to the embodiment of the present invention will be described with reference to FIG. 4. Some of the processes described below may be performed in an order different from the order described below or may be omitted.

First, the distributed inference system 100 may compress and/or lighten a deep learning model (large model) (S401). The distributed inference system 100 may compress and/or lighten the deep learning model using technologies such as quantization, pruning, knowledge distillation, model compression, neural architecture search (NAS), singular vector decomposition (SVD), and sparsity.

Next, the distributed inference system 100 may partition the deep learning model into the plurality of sub-models (S403). The distributed inference system 100 may partition the deep learning model in consideration of the specifications of the internal and external infrastructure resources 10 and 20.

Subsequently, the distributed inference system 100 may allocate the plurality of sub-models to the internal and external infrastructure resources 10 and 20 (S405). The distributed inference system 100 may allocate the sub-model to which the data including the sensitive information is input to the internal infrastructure resource 10. When the internal infrastructure resource 10 may not process all of the sub-models to which the data including the sensitive information is input, the distributed inference system 100 may partition the layers of the neural network of the corresponding sub-model and allocate the layer close to the input side among the partitioned layers to the internal infrastructure resource 10. In various embodiments, the distributed inference system 100 may allocate the input tensor of the corresponding sub-model, which inputs the data including the sensitive information, to the internal infrastructure resource 10 when the internal infrastructure resource 10 may not process all of the sub-models.

Then, the distributed inference system 100 may perform the inference by executing the plurality of sub-models allocated to the internal and external infrastructure resources 10 and 20 (S407). In various embodiments, the distributed inference system 100 may monitor the status of the internal and external infrastructure resources 10 and 20 and reallocate the plurality of sub-models to the internal and external infrastructure resources 10 and 20 according to the status of the internal and external infrastructure resources 10 and 20.

Next, the distributed inference system 100 may receive the inference results of each of the plurality of sub-models from the internal and external infrastructure resources 10 and 20 (S409) and may generate the inference results of the deep learning model from the received inference results (S411). The distributed inference system 100 may generate the inference results of the deep learning model by integrating and processing the inference results of each sub-model received from the internal and external infrastructure resources 10 and 20.

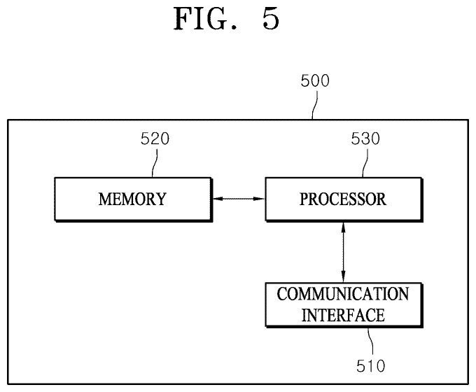

FIG. 5 is a block diagram illustrating an electronic device according to an embodiment of the present invention.

The distributed inference system 100 according to the embodiment of the present invention may be implemented in an electronic device. Referring to FIG. 5, the electronic device 500 in which the distributed inference system 100 is implemented may include a communication interface 510, one or more memories 520, and one or more processors 530.

The communication interface 510 may perform communication with an external device. The communication interface 510 may perform communication with various types of external devices according to various types of communication methods. The communication interface 510 may perform communication with each device within the internal and external infrastructure resources 10 and 20.

At least one instruction executed by the processor 530 may be stored in the memory 520. The memory 520 may be implemented as a volatile storage medium and/or a non-volatile storage medium and may be implemented as, for example, a read only memory (ROM) and/or a random access memory (RAM). The memory 520 may store various types of information required while performing the operation of the processor 530. The memory 520 may store various types of information calculated while the processor 530 operates. The deep learning model and the input data associated with the deep learning model may be stored in one or more memories 520.

The processor 530 may be operatively connected to the communication interface 510 and the memory 520. The processor 530 may be implemented as a central processing unit (CPU) or a system on chip (SoC) and may operate an operating system or applications to control a plurality of hardware or software components connected to the processor 530, thereby performing various data processing and operations. The processor 530 may be configured to execute at least one command stored in the memory 520 and store the execution result data in the memory 520.

The large model or deep learning model, and the modules 110-180 of the distributed inference system 100, may be implemented as or include software or hardware, or a combination of software and hardware. For example, the deep learning model and modules 110-180 implemented as software may be stored in memory 520 and include instructions (alternatively, “programs,” “code” or “program code”) executable by the processor 530 to perform the various operations described herein. The deep learning model and modules 110-180 implemented as hardware or a combination of software and hardware may include, for example, firmware and/or one or more ASICs (application specific integrated circuits).

One or more processors 530 may partition the deep learning model into the plurality of sub-models based on the deep learning model stored in one or more memories 520 and the input data associated with the deep learning model.

The internal resource device and/or the external resource device may include a plurality of devices having different data throughput. The one or more processors 530 may partition the plurality of sub-models into at least some of the plurality of sub-models having different sizes in consideration of the data throughput of the internal resource device and the external resource device.

The one or more processors 530 may distribute and schedule the plurality of sub-models to the internal resource device and the external resource device based on the input data of each of the plurality of sub-models. The one or more processors 530 may transmit (deploy) each sub-model and the input data to the internal resource device and the external resource device.

The input data associated with the deep learning model may be partitioned into data (data including sensitive information) that may be transmitted only to the internal resource device and data (data that does not include sensitive information) that may be transmitted to the external resource device.

The one or more processors 530 may allocate the sub-model to which the data that may be transmitted only to the internal resource device is input to the internal resource device.

The one or more processors 530 may perform distributed scheduling by further considering the specifications of the internal resource device and the external resource device.

When the internal resource device may not process all of the sub-models to which the data that may be transmitted only to the internal resource device is input, the one or more processors 530 may partition the layer of the neural network of the sub-model to which the data that may be transmitted only to the internal resource device is input and allocate the layer closer to the input side among the partitioned layers to the internal resource device.

When the internal resource device may not process all of the sub-models to which the data that may be transmitted only to the internal resource device is input, the one or more processors 530 may allocate the input tensor of the sub-model to which the data that may be transmitted only to the internal resource device is input to the internal resource device.

The internal resource device and the external resource device may execute the sub-models to perform the inference. The one or more processors 530 may receive the inference results of each sub-model from the internal resource device and the external resource device and may generate the results of the deep learning model through the received inference results.

As described above, according to one aspect of the present invention, by distributing the inference of the large model by utilizing the internal and external infrastructure resources composed of the heterogeneous devices, it is possible to easily perform the inference of the large model even when there is insufficiency related to its own internal infrastructure resources.

According to one aspect of the present invention, by processing the sensitive information included in the input data through the internal infrastructure resources, it is possible to prevent the sensitive information from being exposed to the outside while performing the distributed processing of the inference of the large model.

According to one aspect of the present invention, by partitioning and allocating the large model in consideration of the status of the internal and external infrastructure, it is possible to efficiently utilize the internal and external infrastructure resources.

Although the present invention has been described with reference to embodiments shown in the accompanying drawings, it is only an example. It will be understood by those skilled in the art that various modifications and other equivalent exemplary embodiments are possible based on the present invention. Accordingly, a true technical scope of the present invention is to be determined by the spirit of the appended claims.

What is claimed is:

1. An electronic device, comprising:
one or more memories; and
one or more processors,
wherein the one or more processors:
partition a deep learning model stored in the one or more memories into a plurality of sub-models based on the deep learning model and input data associated with the deep learning model,
perform distributed scheduling of the plurality of sub-models to an internal resource device and an external resource device based on the input data associated with the deep learning model,
receive inference results of each sub-model from the internal resource device and the external resource device, and
calculate results of the deep learning model through the received inference results.

2. The electronic device of claim 1, wherein the input data associated with the deep learning model is partitioned into data allowed to be transmitted only to the internal resource device and data allowed to be transmitted to either or both of the internal resource device and the external resource device.

3. The electronic device of claim 2, wherein the one or more processors allocate a sub-model to which the data allowed to be transmitted only to the internal resource device is input to the internal resource device.

4. The electronic device of claim 2, wherein the one or more processors perform the distributed scheduling by further considering specifications of the internal resource device and the external resource device.

5. The electronic device of claim 4, wherein, when the internal resource device does not process all of sub-models to which the data allowed to be transmitted only to the internal resource device is input, the one or more processors partition layers of a neural network of a sub-model to which the data allowed to be transmitted only to the internal resource device is input, and allocate a layer of an input side among the partitioned layers to the internal resource device.

6. The electronic device of claim 4, wherein, when the internal resource device does not process all of sub-models to which the data allowed to be transmitted only to the internal resource device is input, the one or more processors allocate an input tensor of a sub-model to which the data allowed to be transmitted only to the internal resource device is input to the internal resource device.

7. The electronic device of claim 1, wherein at least one of the internal resource device or the external resource device includes a plurality of devices having different data throughput, and
the one or more processors partition the plurality of sub-models into some having different sizes in consideration of the different data throughput of the plurality of devices.

8. The electronic device of claim 1, wherein the deep learning model is a large model.

9. A distributed inference method for a large model, comprising:
partitioning a deep learning model into a plurality of sub-models based on the deep learning model and input data associated with the deep learning model;
distributing and scheduling the plurality of sub-models to an internal resource device and an external resource device based on the input data associated with the deep learning model;
transmitting each sub-model and the input data to the internal resource device and the external resource device;
receiving inference results of each sub-model from the internal resource device and the external resource device; and
calculating results of the deep learning model through the received inference results.

10. The distributed inference method of claim 9, wherein the input data associated with the deep learning model is partitioned into data allowed to be transmitted only to the internal resource device and data allowed to be transmitted to either or both of the internal resource device and the external resource device.

11. The distributed inference method of claim 10, wherein, in the distributing and scheduling, a sub-model to which the data allowed to be transmitted only to the internal resource device is allocated to the internal resource device.

12. The distributed inference method of claim 10, wherein the distributing and scheduling is performed by further considering specifications of the internal resource device and the external resource device.

13. The distributed inference method of claim 12, wherein, in the distributing and scheduling, when the internal resource device does not process all of sub-models to which the data allowed to be transmitted only to the internal resource device is input, the one or more processors partition layers of a neural network of a sub-model to which the data allowed to be transmitted only to the internal resource device is input, and allocate a layer of an input side among the partitioned layers to the internal resource device.

14. The distributed inference method of claim 12, wherein, in the distributing and scheduling, when the internal resource device does not process all of sub-models to which the data allowed to be transmitted only to the internal resource device is input, the one or more processors allocate an input tensor of a sub-model to which the data allowed to be transmitted only to the internal resource device is input to the internal resource device.

15. The distributed inference method of claim 9, wherein at least one of the internal resource device or the external resource device includes a plurality of devices having different data throughput, and
in the partitioning of the deep learning model into the plurality of sub-models, the one or more processors partition the plurality of sub-models into some having different sizes in consideration of the different data throughput of the plurality of devices.

16. A distributed inference method for a large model, comprising:
partitioning a deep learning model into a plurality of sub-models based on the deep learning model and input data associated with the deep learning model;
distributing and scheduling the plurality of sub-models to an internal resource device and an external resource device based on input data of each of the plurality of sub-models, the input data associated with the deep learning model being partitioned into data allowed to be transmitted only to the internal resource device and data allowed to be also transmitted to the external resource device; and
transmitting each sub-model and the input data of each of the plurality of sub-models to the internal resource device and the external resource device.

17. The distributed inference method of claim 16, wherein, in the distributing and scheduling, a sub-model to which the data allowed to be transmitted only to the internal resource device is allocated to the internal resource device.

18. The distributed inference method of claim 16, wherein the distributing and scheduling is performed by further considering specifications of the internal resource device and the external resource device.

19. The distributed inference method of claim 16, wherein, in the distributing and scheduling, when the internal resource device does not process all of sub-models to which the data allowed to be transmitted only to the internal resource device is input, the one or more processors partition layers of a neural network of a sub-model to which the data allowed to be transmitted only to the internal resource device is input, and allocate a layer of an input side among the partitioned layers to the internal resource device.

20. The distributed inference method of claim 16, wherein, in the distributing and scheduling, when the internal resource device does not process all of sub-models to which the data allowed to be transmitted only to the internal resource device is input, the one or more processors allocate an input tensor of a sub-model to which the data allowed to be transmitted only to the internal resource device is input to the internal resource device.
